(19) United States
(12) Patent Application Publication
(10) Pub. No.: US 2017/0337192 A1
(43) Pub. Date: Nov. 23, 2017

(54) NETWORK NODE, INDEXING SERVER AND METHODS PERFORMED THEREBY FOR SUPPORTINGINDEXING OF AUDIO VISUAL CONTENT

(71) Applicant: TELEFONAKTIEBOLAGET LM ERICSSON (PUBL), Stockholm (SE)

(72) Inventors: Tommy ARNGREN, Södra Sunderbyn (SE); Johan KÖLHI, Vaxholm (SE); Tim Kornhammar, Solna (SE)

(73) Assignee: TELEFONAKTIEBOLAGET LM ERICSSON (PUBL), Stockholm (SE)

(21) Appl. No.: 15/536,590

(22) PCT Filed: Dec. 16, 2014
(86) PCT No.: PCT/SE2014/051513

§ 371 Date: Jun. 15, 2017

(51) Int. Cl. G06F 17/30; H04N 21/8405

(52) U.S. Cl. CPC G06F 17/3002; G06F 17/30283; H04N 21/8405

(57) ABSTRACT

A proxy, an indexing server and methods performed thereby are provided for supporting indexing of audio visual content. According to the method performed by the proxy, a plurality of service requests related to audio visual content are received. The requests originate from a number of devices. Further, a set of most frequently requested audio visual content is identified, based on the plurality of service request. The method further comprises indicating the set of audio visual content to an indexing server. Performing of the method enables the indexing server to prioritize among audio visual content, e.g. to determine an or of indexing of audio visual content.

### TECHNICAL FIELD

The solution described herein generally relates to a network node, an indexing server, and methods performed thereby, for supporting indexing of audio visual content, and particularly to handling indexing of large amounts of audio visual content.

### BACKGROUND

Online video has become one of the most popular forms of Internet content. A massive amount of video content is being uploaded to video streaming sites every single minute. YouTube alone is receiving over 100 hours of new video content per minute. Further, by 2017, 80-90% of all consumer Internet traffic is expected to be video. Video is starting to dominate also in mobile networks. According to recent reports, mobile video is already accounting for 40% of all mobile data traffic. The growing importance and increasing amount of online video is creating the need for technologies that can automatically extract information from videos for instance to enable automatic annotation i.e., so-called tagging, of videos for the purpose of interactive video and search. Between 2012 and 2013, interactive video ad impressions increased by 77%.

There are different ways to automatically extract information or to identify content within audio visual content, e.g. using Open CV (Open source Computer Vision), which is an open source computer vision library for face, object, voice and OCR (Optical Character Recognition) detection, or, ACR (Automatic Content Recognition), which is used by applications like Shazam and SoundHound.

Another possibility is to identify and tag objects, such as a face, a brand or an object within e.g. video. The traditional approach for doing this is to create the objects manually. However, companies such as wireWAX, Cinematique, ClickThrough, and IVOTek have solutions that automatically recognize and motion-track faces appearing in a video, and even tag them with clickable hotspots that the customer can then customize. To add hotspots to objects other than faces, the user typically needs to draw a box around the object on one frame. This box is called the anchor region and the frame in which it is first tagged is the anchor frame. The tools will then automatically motion-track that object in future frames without the user having to tag it again. This technology is mainly used for Interactive Video and advertising.

Videos today are mainly manually tagged, indexed and described. This does not provide a good or simple way to find or present extra value concerning the video. Manual tagging and indexing throughout a video requires a person to manually process the video frame by frame, which does not scale. This is a problem given the constantly increasing amount of content to be handled.

### SUMMARY

Today, videos are not automatically indexed or tagged and the amount of audio visual content waiting to be indexed is very large and increases by the minute. It would be desirable to find a way to handle the indexing of these large amounts of content. Herein is provided a solution which enables adaptive tagging and indexing based popularity and user data, e.g. by combining popularity, subscriber data and hardware-ID to initiate tagging and indexing of audio visual content distributed over many different sites.

According to a first aspect, a method for supporting indexing of audio visual content is provided. The method is to be performed by a network node in a communication network, where the network operates as a proxy for the communication network. The method comprises receiving a plurality of service requests related to audio visual content, where the requests originate from a number of devices. The method further comprises identifying a set of most frequently requested audio visual content, based on the plurality of service requests; and further indicating the set of audio visual content to an indexing server. By performing the method, the indexing server is enabled to prioritize among audio visual content, e.g. to determine an order of indexing of audio visual content.

According to a second aspect, a method for supporting indexing of audio visual content is provided. The method is to be performed by an indexing server, where the indexing server is operable to index audio visual content. The method comprises receiving an indication of a set of most frequently requested audio visual content from a network node acting as a proxy for a communication network. The method further comprises determining which audio visual content to index based on the indication; and it also comprises indexing the determined audio visual content.

According to a third aspect, a network node is provided, which is operable in a communication network. The network node is configured for operating as a proxy for the communication network. The network node is further configured to receive a plurality of service requests related to audio visual content, where the requests originate from a number of devices. The network node is further configured to identify a set of most frequently requested audio visual content, based on the plurality of service requests; and to indicate the set of audio visual content to an indexing server.

According to a fourth aspect, an indexing server is provided, which is configured for indexing of audio visual content. The indexing server is further configured to receive an indication of a set of most frequently requested audio visual content from a network node, which acts as a proxy for a communication network. The indexing server is further configured to determine which audio visual content to index based on the indication; and to index the determined audio visual content.

According to a fifth aspect, a computer program is provided, comprising instructions which, when executed on at least one processor, cause the at least one processor to carry out the method according to the first aspect.

According to a sixth aspect, a carrier is provided, which contains a computer program according to the seventh aspect.

Advantages of embodiments of the proposed solution comprise that resources for automatic indexing and tagging may be utilized based on content popularity. Further, popular content may be indexed first, which enables enhanced experience of popular content. Further, additional information, such as index data, popularity counter, and popularity profiles may be collected, analyzed and stored in association with audio visual content. Such additional information can be made available to content providers, which may expose at least parts of the additional information to their customers, e.g. to enhance the experience of their service. Further, audio visual content and/or associated additional information may be selectively offered to customers based on popularity profiles and user related information associated with a certain audio visual content.

### BRIEF DESCRIPTION OF DRAWINGS

The foregoing and other objects, features, and advantages of the technology disclosed herein will be apparent from the following more particular description of embodiments as illustrated in the accompanying drawings. The drawings are not necessarily to scale, emphasis instead being placed upon illustrating the principles of the technology disclosed herein.

FIG. 1a is a schematic block diagram showing an exemplifying system in which different embodiments may be applied.

FIG. 1b is a schematic block diagram illustrating an exemplifying method according to an embodiment.

FIGS. 2-3 are flowcharts illustrating exemplifying methods performed by a network node according to different embodiments.

FIGS. 4-5 are flowcharts illustrating exemplifying methods performed by an indexing server according to different embodiments.

FIGS. 6a-6c are schematic block diagrams illustrating different implementations of a network node according to exemplifying embodiments.

FIGS. 7a-7c are schematic block diagrams illustrating different implementations of an indexing server according to exemplifying embodiments.

### DETAILED DESCRIPTION

The solution which will be described below relates to a system and a method for network proxy initiated indexing, also denoted tagging, of audio visual content based on video popularity. The terms audio visual content, video content, and video will be used interchangeably herein, referring to material such as films, TV-productions, clips from sites such as YouTube or Twich, or any other content comprising audible and/or visible components which may be retrieved and consumed by users in a communication network.

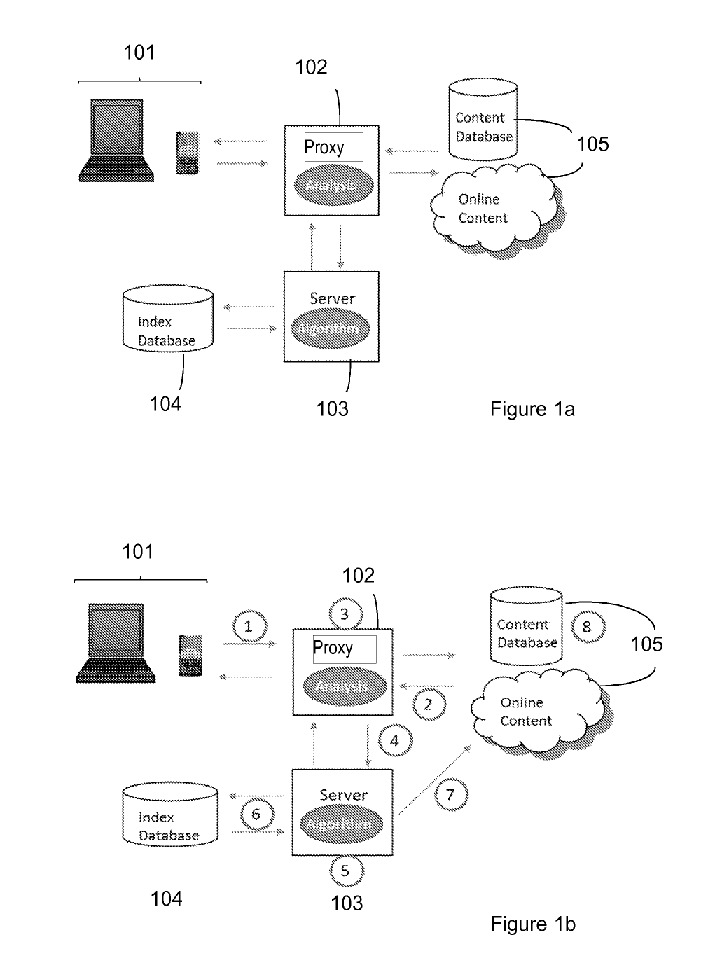

FIG. 1a shows an exemplifying system where embodiments described herein may be applied. The system comprises user operated devices 101 for accessing and consuming video content. The system further comprises a proxy 102, through which the requests for content, originating from the devices 101, passes, and where the requests may be analyzed. Further, the system comprises an indexing server 103 connected to an index database 104. The indexing server 103 is operable to index, which may also be denoted “to tag”, audio visual content, and the indices are stored in the index database. The system further comprises sources of content 105, comprising the content to be consumed by the users operating the devices 101.

The proxy 102 may e.g. be an enhanced network proxy, such as a multi-purpose and IPv6-ready network node that offers seamless integration with the core network through standard interfaces such as HTTP (Hypertext Transfer Protocol), TCP (Transmission Control Protocol), RTSP (Real Time Streaming Protocol), UDP (User Datagram Protocol), etc. Such an enhanced network proxy is service aware and can handle all TCP based traffic as well as content filtering. Proxy services like user identification and access control can be applied per protocol, and statistics can be generated per protocol.

### Exemplifying Embodiments

Below, exemplifying embodiments will be described.

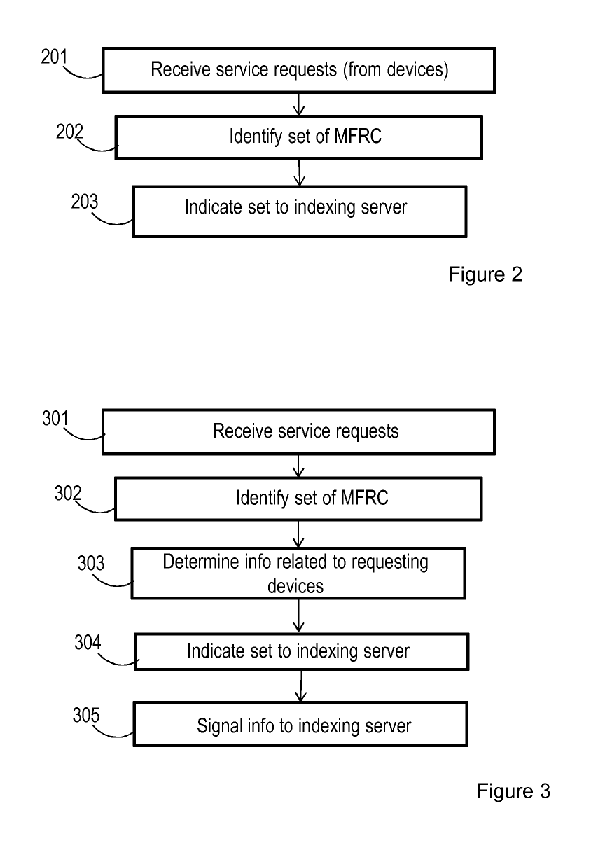

First, exemplifying embodiments performed by a network node (proxy) and an indexing server will be described with reference to FIGS. 2-5. Then, further below, a general exemplifying method embodiment performed in the system illustrated in FIG. 1a will be described with reference to FIG. 1b

Embodiments described herein enable indexing of content from various sites based on popularity. This enables that the indexation processing capacity of an indexing server, such as 103 in FIGS. 1a and 1b, may be used only on popular content, which is actually requested by users, and that an index database, such as 104 in FIGS. 1a and 1b, may be used as a search engine for audio visual content, no matter what site it comes from, which is a great advantage.

FIG. 2 illustrates a method performed by a network node operable in a communication network, and the network node operates as a proxy for the communication network. The network node corresponds to a node such as the network node 102 in FIGS. 1a and 1b. The method is suitable for supporting indexing of audio visual content. The method comprises receiving 201 a plurality of service requests related to audio visual content. The requests originate from a number of devices, such as the devices 101, illustrated in FIG. 1. The method further comprises identifying 202 a set of most frequently requested audio visual content, also denoted “MFRC” in FIGS. 2-5, based on the plurality of service requests; and indicating 203 the set of audio visual content to an indexing server, such as the server 103 illustrated in FIG. 1. By the performing of this method, the indexing server is enabled to prioritize among audio visual content, e.g. to determine an order of indexing of audio visual content.

Since the network node acts as a proxy for the communication network, it has access to requests for content from users in the communication network. The users may request audio visual content from many different content providers and they may be using different services for requesting and consuming the content. The requests related to audio visual content comprise information identifying the requested content, directly or indirectly. For example, the information may be or comprise a so-called uniform resource locator, URL, or some other link or pointer to a content item stored e.g. in a content database of a content provider. This information may be used by the network node, e.g. by starting a counter for requests related to the specific content item or link. Such a counter may then be increased for each received request related to this specific content item or link, thus keeping track of the number of times a specific content has been requested.

The identifying of a set of the most frequently requested audio visual content may comprise counting, e.g. by use of a counter as mentioned above, the number of times each audio visual content item, e.g. represented by a link or pointer, is requested, and identifying a number of audio visual content items that have been requested most, by comparing the counters. This could also be described e.g. as identifying a set of counters, from among a group of counters, which have registered the most number of received requests, assuming that each counter is associated with an audio visual content item or a link to such an item.

The identifying of the set of most frequently requested audio visual content may be based on service requests received e.g. during a certain period of time, such as an hour, a day or a week. If, for example, a time period of 24 hours is used, all already existing counters, or corresponding, may be removed or reset at the beginning of each new 24-hour period. Then, when a certain audio visual content is requested for the first time during the 24-hour period, a counter is started, e.g. initiated and set to “1”, for said certain audio visual content. The counter may then be increased for each further received request related to the same content item or link during the rest of the 24 hours. At the end of the 24-hour period, the counters which have reached the highest numbers are identified, and the associated audio visual content items or links may be indicated to an indexing server. A respective percentage of a total number of requests received during the 24 hours for each of the most frequently requested content items or links may be signaled or indicated to the indexing server together with an identifier of the corresponding audio visual content. The total number of requests may also be indicated to the indexing server.

As an alternative or a complement to a time period, the identifying of the set of audio visual content may be based on a certain amount of received service requests, for example 10.000, 100.000 or 1.000.000 requests. The amount of received service requests may be related to the total number of received requests, or to a subset thereof, e.g. to requests related to one or more audio visual content items. For example, a set of the most frequently requested audio visual content could be indicated to an indexing server when the sum of the requests for the three most popular items exceeds a threshold value, e.g. 100.000 requests.

Further, since the network node acts as a proxy for the communication network, it not only has access to requests for content from users in the communication network, as mentioned above, but also to information about the devices used (by the users) for making the request, and to information about the users associated with the devices. Such information may be related to e.g. one or more of: a device type, e.g. hardware ID; a location of the device, e.g. area or country; a requested service type, e.g. which application/language that is used for requesting the audio visual content; a time of day of request; a subscription type; age information on user; and statistics related to user behavior. Consequently, the method described above may further comprise determining information associated with devices, which have requested audio visual content. The expression “associated with devices” here also includes the option of user related information associated with a specific user, which is using a respective device. For example, and as illustrated in FIG. 3, information associated with the devices which have requested the audio visual content in the set of most frequently requested audio visual content may be determined 303 and be signaled 305 to the indexing server in connection with indicating the set. For example, determining such information may comprise analyzing, grouping and/or storing such information for all received service requests, and then selecting the information associated with the requests for the identified most frequently requested audio visual content.

Further, the identifying of the most frequently requested audio visual content may be based on service requests associated with a certain type of device, or on requests from devices in a certain area. In other words, the set of most frequently requested audio visual content may be identified e.g. as the set which was most frequently requested by users of a certain age in a certain area during a certain time period. This may be useful when focusing on a special group of users, e.g. when striving to give special service to a high priority group of users.

The indexing server may indicate to the network node which audio visual content that has already been indexed. To this group may further be referred content which is decided to be indexed soon, e.g. is placed in a queue for being indexed. The network node may consequently receive an indication or notification, from the indexing server, of which audio visual content that is taken care of, i.e. is set out to be or already has been indexed. This indicated audio visual content may then be excluded when identifying new sets of most frequently requested content. The requests for the audio visual content indicated as already indexed may still be counted, but when the set of most frequently requested content is to be identified, such requests and associated counters may be disregarded, even though being related e.g. to the most popular content. The exclusion of the already indexed content avoids that the network node indicates already indexed content items to the indexing server, which would be a waste of resources.

Embodiments herein further relate to a method performed by an indexing server, as the indexing server 103 described above, i.e. a server to which the network node indicates the set of most frequently requested audio visual content. The indexing server is operable to index audio visual content, by means of e.g. adaptive automatic face and speech recognition, optical character recognition, OCR, etc.

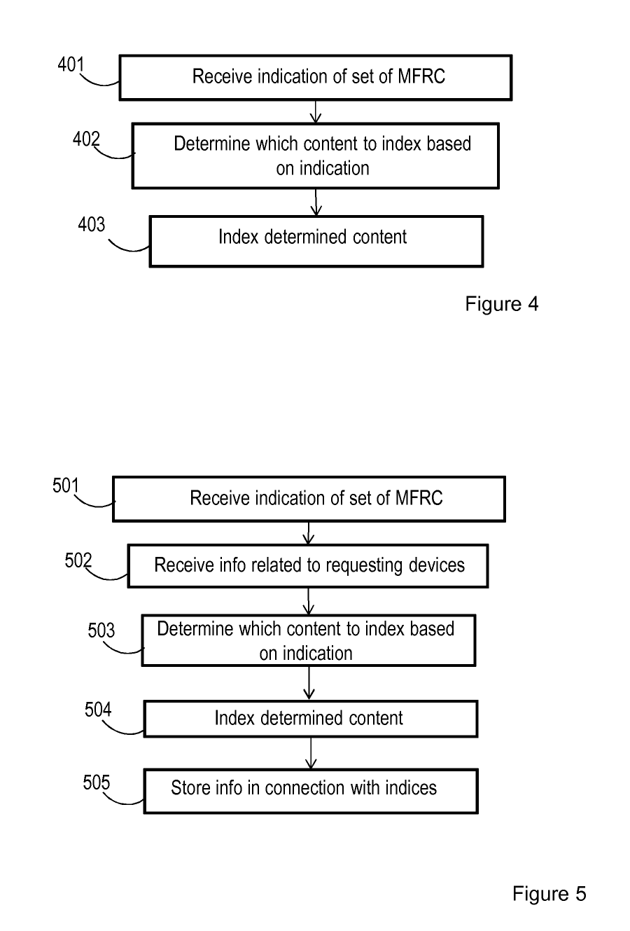

An exemplifying method embodiment to be performed by an indexing server will be described below with reference to FIG. 4. The method comprises receiving 401 an indication of a set of most frequently requested audio visual content from a network node, which acts as a proxy for a communication network. It should be noted that the indexing server may receive such indications from a plurality of network nodes acting as proxies for a number of communication networks, and thereby aggregate information on the most requested audio visual content.

The method further comprises determining 402 which audio visual content to index based on the indication; and then indexing 403 the determined audio visual content. The indication may comprise a set of links or pointers to audio visual content items, or some other type of representation of the set of most requested content. Assuming, as an example, that the indication comprises e.g. three urls, indicating the three most requested audio visual content items during a time period of e.g. 24 hours, at the network node from which the indication is received. The indication may further comprise the percentage for the respective items of the total number of requests during the period, such as e.g.: url_1: 21%; url_2: 8%; url_3: 6%. The indication may further comprise information indicating at least an approximation of the total number of requests during the period, such that the indexing server may determine how large the actual demand for the items has been, and put it in relation to indications received from other network nodes.

Assuming, again as an example that the indexing server receives an indication of seven audio visual content items from a network node handling an extensive amount of traffic. The indexing server may then determine, based on the received indication, that the seven indicated audio visual content items should be indexed at the next possible instance, e.g. by placing a reference to the items in an indexing queue. When the indexing server receives indications from a plurality of nodes, the decision of which content to index may be based on information comprised in all or a subset of the indications. The indications may be weighted, based on different criteria, such as total number of requests at the network node. Thereby, it is not with necessity that an audio visual content item indicated as being the most popular by one network node is actually placed in a queue for indexing, since it may be other items that are determined to be more popular, e.g. in total numbers, based on indications for the same period from other network nodes.

The determining of which audio visual content to index may comprise determining of a prioritized order for the audio visual content to index. The audio visual content items may then be indexed according to the determined prioritized order. This may be achieved e.g. by the order in which references to the content items are placed in an indexing queue. However, the determined order must not entirely follow e.g. the order of popularity in total numbers, which will be further described below.

As illustrated in FIG. 5, the indexing server may further receive 502 information associated with devices having requested the audio visual content of the indicated set. This information is in such cases received from the network node. Such information may e.g. be stored 505 in connection with the content indices resulting from indexing of the corresponding content items. Such received information may be related to e.g. one or more of: a device type, e.g. hardware ID; a location of the device, e.g. area or country; a requested service type, e.g. which application/language that is used for requesting the audio visual content; a time of day of request; a subscription type; age information on user; and statistics related to user behavior. For example, characteristics that represent e.g. a majority of the subscribers that consume, or at least have requested, an actual content item may be stored in association with the content item indices, and/or be provided to the content provider. Such characteristics could be e.g. a country or region, in which the content item is especially popular, a type of device that is frequently used for consuming, or at least requesting, the content item; a time of day when the content item is typically requested; an age group in which the content item is particularly popular, etc.

The indexing server may further inform one or more network nodes (e.g. from which it has received an indication of a set of content) of which audio visual content that has been indexed, or is about to be indexed. Thereby, the one or more network nodes may exclude already indexed content from their future indications of most frequently requested audio visual content. The indexing server may inform the one or more network nodes by indicating the indexed content by signaling e.g. urls or other representations of content media items. Such signaling could be done by sending a http response, comprising a content identification or url and an indicator such as e.g. a flag indicating whether the indicated content is indexed or not.

The method illustrated in FIG. 1b includes the following exemplifying actions, which are marked with corresponding numbers in the figure:
1. A user of a device 101 selects and clicks an url representing a video, e.g. at the site YouTube, thereby initiating a request for a service, which will go through the proxy;
2. The video represented by the url is downloaded or streamed to the device 101 (if the request for service is granted);
3. The proxy 102 caches video content (audio visual content) requested through the proxy. The proxy 102 counts the number of requests related to a particular video. The proxy collects, groups and caches subscriber data, such as country, language, hardware id, etc, of users/devices accessing popular content;
4. When a request counter of the proxy 102 reaches a certain threshold, or, when a certain time period has elapsed, a push message comprising e.g. url, counter value, and/or subscriber group data related to the one or more most frequently requested videos is sent to the indexing server 103;
5. The indexing server 103 polls the cached content and starts to index the one or more videos indicated in the push message;
6. The indexing server 103 stores index data and related subscriber data in a database 104;
7. When the one or more videos have been indexed, a push message may be transmitted to the content provider, informing them about available indices, tags, user group data etc, related to a certain url;
8. The content provider may then expose this metadata to users as either a search engine for videos, overlayed data or statistics on the type of videos that are popular. Examples of overlayed data may be e.g.:
   a. Subtitles from speech recognition.
   b. Marked faces or objects, example a text with the name “Barack Obama” if he appears on the video.
   c. Advertisements relative to names, places or brands displayed in the video;
   d. Information from user group data, such as country, city, etc.;

The content provider will further be able to target specific subscribers, e.g. with offerings matching the popularity profile related to certain video content.

### Hardware Implementations

The methods and techniques described above may be implemented in different ways, of which some will be described below.

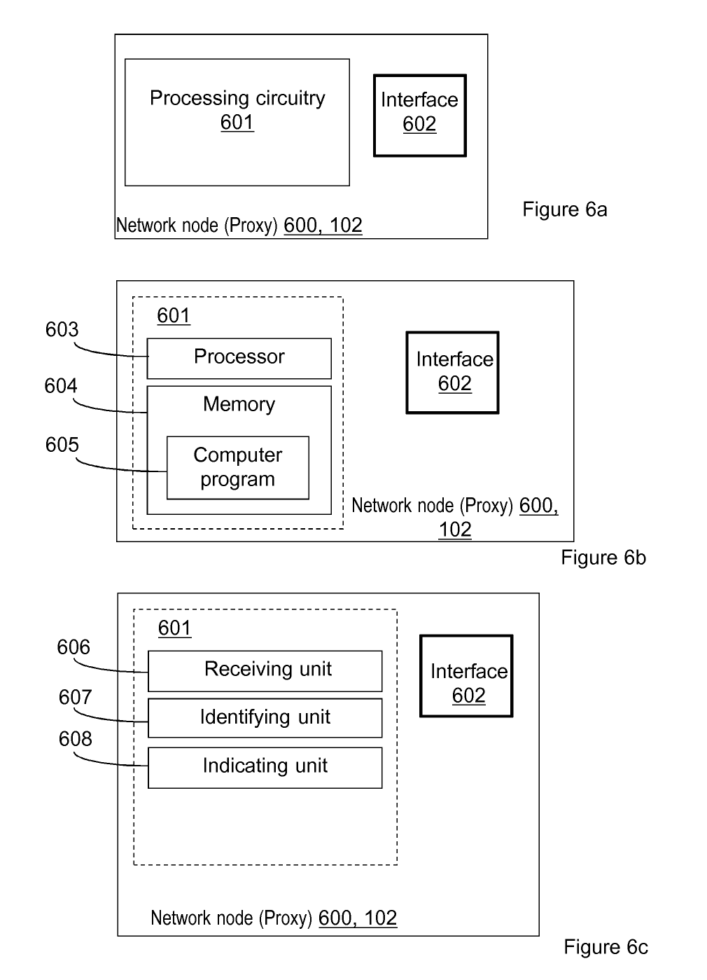

Network Node, FIGS. 6a-6c

An exemplifying embodiment of a network node 600, such as the network node 102, is illustrated in a general manner in FIG. 6a. The network node will be denoted “proxy” below, to emphasize that it is operable as a proxy in a communication network. The proxy 600 is configured to perform at least one of the method embodiments described above e.g. with reference to FIGS. 2-3. The proxy 600 is associated with the same technical features, objects and advantages as the previously described method embodiments. The node will be described in brief in order to avoid unnecessary repetition.

The proxy may be implemented and/or described as follows:

The proxy 600 is configured for supporting indexing of audio visual content. The proxy 600 comprises processing circuitry 601 and a communication interface 602. The processing circuitry 601 is configured to cause the proxy 600 to receive a plurality of service requests related to audio visual content, the requests originating from a number of devices. The processing circuitry 601 is further configured to cause the proxy to identifying a set of most frequently requested audio visual content, based on the plurality of service requests; and further to indicate the set of audio visual content to an indexing server. The communication interface 602, which may also be denoted e.g. Input/Output (I/O) interface, includes a network interface for at least sending data to and receiving data from other network nodes and an indexing server.

The processing circuitry 601 could, as illustrated in FIG. 6b, comprise processing means, such as a processor 603, e.g. a CPU, and a memory 604 for storing or holding instructions. The memory would then comprise instructions, e.g. in form of a computer program 605, which when executed by the processing means 603 causes the proxy 600 to perform the actions described above, e.g. with reference to FIGS. 1b and 2-3.

An alternative implementation of the processing circuitry 601 is shown in FIG. 6c. The processing circuitry here comprises a receiving unit 606, configured to cause the proxy to receive a plurality of service requests related to audio visual content from a number of devices. The processing circuitry further comprises an identifying unit 607, configured to cause the proxy to identify a set of most frequently requested audio visual content, based on the plurality of service requests. The processing circuitry further comprises an indicating unit 608, configured to cause the proxy to indicate the set of audio visual content to an indexing server. The processing circuitry could comprise further units, such as a determining unit for determining information associated with devices, out of the number of devices, which have requested the audio visual content in the set and signaling the determined information to the indexing server in connection with indicating the set.

The proxys described above could be configured for the different method embodiments described herein, such as determining the set of most frequently requested audio visual content based on requests received during a certain period of time, or based on a certain number of received requests, etc.

The proxy 600 may be assumed to comprise further functionality, for carrying out regular node functions.

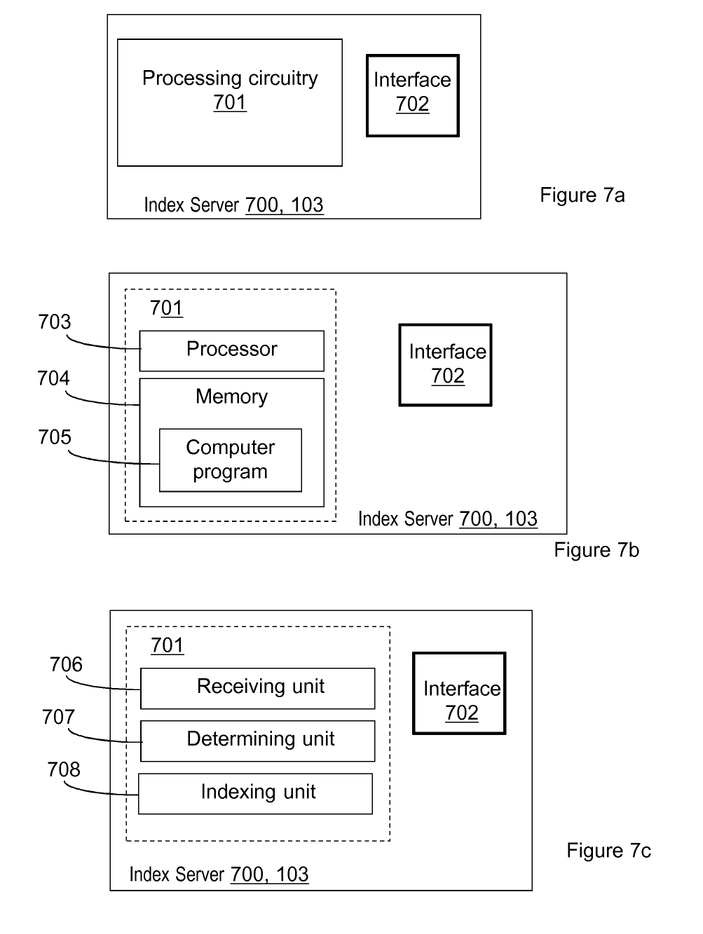

Indexing Server, FIGS. 7a-7c

Embodiments herein also relate to an indexing server 700 configured for carrying out embodiments of the method described as performed by an indexing server above. An exemplifying embodiment of an indexing server is illustrated in a general manner in FIG. 7a. The network node 700 is configured to perform at least one of the method embodiments described above e.g. with reference to FIG. 4 or 5. The network node 700 is associated with the same technical features, objects and advantages as the previously described method embodiments. The indexing server will be described in brief in order to avoid unnecessary repetition.

The network node 700 is configured for supporting indexing of audio visual content. The network node 700 comprises processing circuitry 701 and a communication interface 702. The processing circuitry 701 is configured to cause the indexing server to receive an indication of a set of most frequently requested audio visual content from a network node acting as a proxy for a communication network. The processing circuitry 701 is further configured to cause the indexing server to determine which audio visual content to index based on the indication; and to index the determined audio visual content. The communication interface 702, which may also be denoted e.g. Input/Output (I/O) interface, includes a network interface for sending data to and receiving data from other network nodes.

The processing circuitry 701 could, as illustrated in FIG. 7b, comprise processing means, such as a processor 703, and a memory 704 for storing or holding instructions. The memory would then comprise instructions, e.g. in form of computer program 705, which when executed by the processing means 703 causes the network node 700 to perform the actions described above, e.g. with reference to FIGS. 1b and 4-5.

An alternative implementation of the processing circuitry 701 is shown in FIG. 7c. The processing circuitry here comprises a receiving unit 706, configured to cause the indexing server to receive an indication of a set of most frequently requested audio visual content from a network node acting as a proxy for a communication network. The processing circuitry further comprises a determining unit 706, configured to cause the indexing server to determine which audio visual content to index based on the indication. The processing circuitry further comprises an indexing unit 706, configured to cause the indexing server to index the determined audio visual content, resulting in a set of indices associated with the indexed content.

The network node 700 may be assumed to comprise further functionality, for carrying out indexing server functions.

### Concluding Remarks

The steps, functions, procedures, modules, units and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

Alternatively, at least some of the steps, functions, procedures, modules, units and/or blocks described above may be implemented in software such as a computer program for execution by suitable processing circuitry including one or more processing units. The software could be carried by a carrier, such as an electronic signal, an optical signal, a radio signal, or a computer readable storage medium before and/or during the use of the computer program in the network nodes. The network node and indexing server described above may be implemented in a so-called cloud solution, referring to that the implementation may be distributed, and the network node and indexing server therefore may be so-called virtual nodes or virtual machines.

The flow diagram or diagrams presented herein may be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

Examples of processing circuitry includes, but is not limited to, one or more microprocessors, one or more Digital Signal Processors, DSPs, one or more Central Processing Units, CPUs, and/or any suitable programmable logic circuitry such as one or more Field Programmable Gate Arrays, FPGAs, or one or more Programmable Logic Controllers, PLCs. That is, the units or modules in the arrangements in the different nodes described above could be implemented by a combination of analog and digital circuits, and/or one or more processors configured with software and/or firmware, e.g. stored in a memory. One or more of these processors, as well as the other digital hardware, may be included in a single application-specific integrated circuitry, ASIC, or several processors and various digital hardware may be distributed among several separate components, whether individually packaged or assembled into a system-on-a-chip, SoC.

It should also be understood that it may be possible to re-use the general processing capabilities of any conventional device or unit in which the proposed technology is implemented. It may also be possible to re-use existing software, e.g. by reprogramming of the existing software or by adding new software components.

The embodiments described above are merely given as examples, and it should be understood that the proposed technology is not limited thereto. It will be understood by those skilled in the art that various modifications, combinations and changes may be made to the embodiments without departing from the present scope. In particular, different part solutions in the different embodiments can be combined in other configurations, where technically possible.

When using the word “comprise” or “comprising” it shall be interpreted as non-limiting, i.e. meaning “consist at least of”.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

1. A method for supporting indexing of audio visual content performed by a network node in a communication network, where the network node operates as a proxy for the communication network, the method comprising:
receiving a plurality of service requests related to audio visual content, the requests originating from a number of devices;
identifying a set of most frequently requested audio visual content, based on the plurality of service requests; and
indicating the identified set of audio visual content to an indexing server,
thereby enabling the indexing server to determine a prioritized order among audio visual content based on the identified set.

2. (canceled)

3. (canceled)

4. The method according to claim 1, further comprising:
determining information associated with devices, out of the number of devices, which have requested the audio visual content of the identified set, and
signaling the determined information to the indexing server.

5. The method according to claim 1, wherein the determined information comprises one or more of:
device type;
location of device;
requested service;
time of day of request; and
subscription type.

6. (canceled)

7. A method for supporting indexing of audio visual content, performed by an indexing server, where the indexing server is operable to index audio visual content, the method comprising:
receiving an indication of a set of most frequently requested audio visual content from a network node acting as a proxy for a communication network;
determining which audio visual content to index based on the indicated set; and
indexing the determined audio visual content by prioritizing the audio visual content according to a specific order based on the set of the indication.

8. (canceled)

9. The method according to claim 7, further comprising:
receiving information associated with devices having requested the audio visual content of the set, from the network node; and
storing the information in connection with the content indices.

10. The method according to claim 9, wherein the received information comprises one or more of:
device type;
location of device;
requested service;
time of day of request; and
subscription type.

11. (canceled)

12. (canceled)

13. A network node operable in a communication network, the network node being configured for operating as a proxy for the communication network, the network node being further configured to:
receive a plurality of service requests related to audio visual content, the requests originating from a number of devices;
identify a set of most frequently requested audio visual content, based on the plurality of service requests; and
indicate the identified set of audio visual content to an indexing server

14. (canceled)

15. The network node according to claim 13, being further configured to identify the set of audio visual content based on a certain amount of received service requests, either in total, or for a subset related to one or more audio visual content items or links to such items.

16. The network node according to claim 13, being further configured to:
determine information associated with devices, out of the number of devices, which have requested the audio visual content in the set, and to signal the determined information to the indexing server.

17. (canceled)

18. An indexing server configured for indexing of audio visual content, the indexing server being further configured to:
receive an indication of a set of most frequently requested audio visual content from a network node acting as a proxy for a communication network;
determine which audio visual content to index based on the indicated set; and
index the determined audio visual content, by prioritizing the audio visual content according to a specific order based on the set of the indication.

19. (canceled)

20. The indexing server according to claim 18, being further configured to:
receive information associated with devices having requested the audio visual content of the set, from the network node; and to
store the information in connection with the content indices.

21. The indexing server according to claim 18, being further configured to determine which audio visual content to index based also on corresponding sets of most frequently requested audio visual content received from other network nodes acting as proxy.

22. The indexing server according to claim 18, being further configured to signal information on indexed audio visual content to a network node.

23. A non-transitory program product, comprising instructions which, when executed on at least one processor, cause the at least one processor to carry out the method according to claim 1.

24. (canceled)
